(19) United States
(12) Patent Application Publication
(10) Pub. No.: US 2002/0011840 A1
(43) Pub. Date: Jan. 31, 2002

(54) Sensor for sensing absolute angular position of cylindrical object

(76) Inventor: Hui Li, Vancouver, CA (US)

Correspondence Address: Vermette & Co., Box 40, Granville Square, Suite 230, 200 Granville Street, Vancouver, BC, V6C 1S4, CA

(21) Appl. No.: 09/739,615

(22) Filed: Dec. 19, 2000

(30) Foreign Application Priority Data
Jan. 4, 2000 (CA) 2,293,857

(51) Int. Cl. G01B 7/30; G01B 7/14

(52) U.S. Cl. 324/207.21; 324/207.24; 324/207.25

(57) ABSTRACT

The invention replaces the previously known device using a cogwheel for sensing relative angular position. The sensor module in the invention is parallel to the axis of the shaft whose angular position is to be measured, and instead of a cogwheel, the shaft is provided with an axially aligned screw-threaded portion adjacent the sensor module. The sensors in the sensor module measure instantaneous intensity of a magnetic field in a region proximate a portion of the shaft. The field intensity information provided by the sensors is then converted by a signal processing apparatus to provide a phase change corresponding to the screw threads passing a given one of the sensors. This phase change can then be used to calculate the absolute angular position of the shaft, or combined with the thread pitch of the screw threads to yield a magnitude of linear movement of the shaft.

### FIELD

The invention relates to angular position sensors, and in particular to simple non-contacting means to determine the absolute angular position or the absolute linear position of a rotating shaft of, for example, an electric motor.

### BACKGROUND OF THE INVENTION

One conventional way to measure the absolute angle of the shaft of an electric motor is by measuring the field of a single magnet attached to the shaft so that the magnet spins with the shaft. A number of stationary sensors located around the magnet measure the magnetic field of the magnet. As the magnet spins, the waveform of the measured magnetic field is sinusoidal and can be used to calculate the position and rotational speed of the shaft. It has been found, however, that the most accurate measurements are provided if the magnet is as close to perfectly circular as possible. Such magnets are difficult and expensive to make. Another problem is that adding magnets increases the inertia of the shaft.

As discussed in U.S. Pat. No. 5,367,257 issued to Garshelis, it is known to sense without contact the motion of rotating members by either (1) adding magnetic poles to a circumferential region of a rotating member, either by attaching discrete permanent magnets or by permanently magnetizing local regions of the rotating member, or (2) providing a toothed, ferromagnetic circumferential region of the rotating member (referred to as “a cogwheel” herein, even though gears are typically not involved) and a stationary permanent magnet near the rotating member. In the first case, a magnetic field sensor is placed close to the portion of the rotating member having the magnetic poles. In the second case, the magnetic field sensor is placed between the toothed region and the stationary permanent magnet. Depending upon the character of the shaft, teeth can be cut into the shaft, or a toothed sleeve or bushing or the like can be mounted on the shaft to rotate with the shaft. The magnetic field sensor detects changes in the magnetic field caused either by the motion of the magnetic poles past the sensor or by the variation in the permeance of the magnetic circuit between the toothed ferromagnetic region of the rotating member and the permanent magnet as the teeth move past the permanent magnet. Active magnetic field sensors such as Hall-effect sensors or magnetoresistive sensors are preferred. To achieve accurate measurements, it is necessary to have closely and accurately spaced magnetic poles or notches on the rotating member; these can be difficult and expensive to provide.

Both of the above sensing methods discussed by Garshelis provide only relative angular position unless at least one position on the rotating member is specially marked and the sensor and associated circuitry are configured to distinguish the marked position. If that is done, the absolute position can be calculated, once the mark has passed the sensor, by counting the number of passages of the mark. For an example, see U.S. Pat. No. 5,568,048 issued to Schroeder et al. If no special mark is used, only the position relative to the initial power-up position can be provided.

The present invention was developed from an analysis of a variation on the previously known devices using a cogwheel for sensing relative angular position. This variation includes a sensor module containing four magnetoresistive sensors in a linear array. The array of sensors is aligned in the plane of the cogwheel and in a tangential direction with respect to the cogwheel, and is positioned close to the cogwheel so that the teeth of the cogwheel move past the sensors as the cogwheel rotates. The spacing of the sensors is one-quarter of the distance between the centers of successive teeth of the cogwheel. It has been found that the magnetic field at any sensor is approximately proportional to the distance of that sensor from the surface of the cogwheel, and the instantaneous resistance of any sensor is proportional to the instantaneous magnetic field strength at that sensor. Therefore, the resistance of each of the four sensors may be measured, and consequently the instantaneous angular position of the sensor module relative to each tooth as it passes, are determined by appropriate circuitry using circuit design methods known in the prior art. By counting the passage of teeth, the angular position of the shaft relative to its position when the apparatus was turned on may be determined. The distance between the centers of successive teeth of a cogwheel is referred to in this specification as the “tooth pitch”, or simply the “pitch” if the context is clear.

A screw-threaded shaft portion used as the rotating member in an apparatus for measuring the relative angular position of the rotating member is found in U.S. Pat. No. 3,036,266 issued to Hulls. In Hulls, an electromagnetic transducer for use in a device for positioning tables of machine tools or tool holders is disclosed in which the rotating member is a steel lead screw having cut on its surface a square-cut thread, the width of the thread being equal to the distance between consecutive thread edges (i.e., the troughs and peaks of the square cut being of equal width). Mounted coaxially with the screw is a cylindrical magnetic head having pole pieces at each end whose inner surfaces match the pitch and shape of the screw thread, but do not touch the screw, and are spaced such that the lands of one pole piece with be directly opposite the lands of the screw when the lands of the other pole piece are directly opposite the grooves of the thread. The head also includes two windings, one near each end of the head and each surrounding but not touching the screw. If AC current is passed through the windings, the relative angular position of the screw can be determined by a bridge circuit.

While the Hulls apparatus does measure absolute angular position measurement of a screw-threaded shaft, it does so only in the context of precision linear position measurement of machine tools, an art which is subject to different tolerances than the measurement of the angular position of a rotating shaft, such as the shaft of an electric motor. Hulls also requires the pole pieces to be threaded in the same manner as the screw-threaded shaft in order to measure the reluctance of the magnetic path between the pole pieces. Additionally, these pole pieces must enclose at least half, and preferably the entire screw-threaded shaft for accurate measurement. Furthermore, the sensors disclosed by Hulls encompass multiple screw threads and rely on matching the threading of the poles with the threading on the shaft to produce an accurate result.

### SUMMARY OF THE INVENTION

The present invention replaces the previously known device using a cogwheel for sensing relative angular position. The sensor module in the invention is parallel to the axis of the shaft whose angular position is to be measured, and instead of a cogwheel, the shaft is provided with an axially aligned screw-threaded portion adjacent the sensor module. The sensors in the sensor module measure instantaneous intensity of a magnetic field in a region proximate a portion of the shaft. The field intensity information provided by the sensors is then converted by a signal processing apparatus to provide a phase change corresponding to the screw threads passing a given one of the sensors. This phase change can then be used to calculate the absolute angular position of the shaft, or combined with the thread pitch of the screw threads to yield a magnitude of linear movement of the shaft.

Preferably, the longitudinal extension of the array of sensors must be less than the thread pitch divided by the cosine of the helical angle of the screw thread. It is also preferable for the screw thread to be sinusoidal or approximately sinusoidal (e.g. trapezoidal) to facilitate calculations.

The invention may additionally include a magnet proximate to the sensor array and positioned to establish a magnetic field through the sensors in the sensor array to the screw thread or threads.

Alternatively, the invention may compute a rate of phase change corresponding to screw threads passing a given one of the sensors. This rate of phase change can then be used to calculate an absolute angular velocity for the shaft.

The invention also includes a method of determining the absolute angular position or absolute linear position of a rotating shaft using the apparatus described above.

### BRIEF DESCRIPTION OF THE DRAWINGS

FIG. 1 (prior art) is a schematic axial-sectional fragment view of a cogwheel and sensor module of a known relative-angular-position measuring apparatus.

FIG. 2 (prior art) is a schematic circuit diagram of the sensor module and associated electronic circuitry of the known relative-angular-position measuring apparatus of FIG. 1.

FIG. 3 is an overall schematic fragment elevation view of a preferred embodiment of a fragment of the screw-threaded shaft and sensor module of an embodiment of the absolute-angle measuring apparatus in accordance with the invention.

FIG. 4A is an isometric side elevation fragment view of a fragment of a single-thread screw illustrating the coordinates used to describe the threads of a screw.

FIG. 4B is a schematic elevation view representing the threads of the screw fragment of FIG. 4A.

FIG. 4C is a flat-plane extension view of the screw fragment of FIG. 4A further illustrating the coordinates used to describe the threads of a single-threaded screw.

FIG. 5A is a schematic elevation view representing the threads of a fragment of a double-threaded screw.

FIG. 5B is a flat-plane extension view of the screw fragment of FIG. 5A illustrating the coordinates used to describe the threads of a double-threaded screw and the numbering of the threads.

FIG. 6A is a schematic elevation view representing the threads of a fragment of a triple-threaded screw.

FIG. 6B is a flat-plane extension view of the screw fragment of FIG. 6A illustrating the coordinates used to describe the threads of a triple-threaded screw and the numbering of the threads.

FIG. 7 is a flat-plane extension view of a fragment of a quadruple-threaded screw illustrating the coordinates used in derivation of the relationship between absolute angle and the distances of the sensors from the surface of the screw for any number n of screw threads.

### DETAILED DESCRIPTION OF THE PREFERRED EMBODIMENT

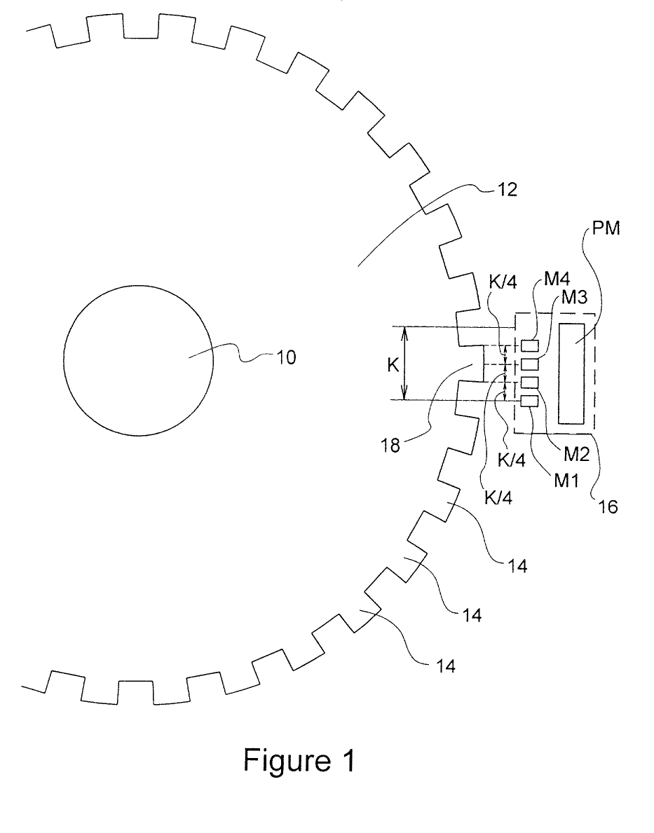

One preferred embodiment of the invention is the combination of a screw-threaded shaft with a sensor module and associated electronic circuitry designed for use in previously known apparatus for measuring the relative angular position of a rotating shaft, for example, an electric motor shaft, as detailed below. As shown in FIG. 1, a magnetic field is produced by a fixed permanent magnet PM located within the sensor module 16, which is positioned close to the shaft 10. The sensor module 16 also includes an array of magnetoresistive or other suitable sensors M1, M2, M3, and M4 positioned between the shaft 10 and the permanent magnet PM. According to the prior art, the sensor module 16 would be positioned close to a cogwheel 12 mounted on and rotating with the shaft 10. The relative angular position of the shaft 10 is then determined by sensing the variation in the magnetic field caused by the passage of the teeth 14 of the cogwheel 12 past the sensor module 16, and then performing calculations on the sensed variation in magnetic field, as detailed below. As the concept of measurement of variation in the magnetic field and then calculation of shaft position is common to both the prior art and the present invention, it is useful first to discuss the prior art.

FIG. 1 illustrates schematically the relationship between the shaft 10, cogwheel 12, and sensor module 16 of a previously known cogwheel apparatus designed by the inventor for measuring the relative angular position of the shaft 10. The cogwheel 12 has teeth 14 having a pitch k. A sensor module 16, comprised of a permanent magnet PM and four magnetoresistive sensors M1, M2, M3, and M4 oriented in the plane of and tangent to the cogwheel 12, is positioned close to the periphery of the cogwheel 12. The centers of the sensors M1, M2, M3, and M4 are spaced a distance k/4 from one another. Reference numeral 18 indicates the particular one of the teeth 14 passing the sensor module 16 at the moment in time represented in FIG. 1.

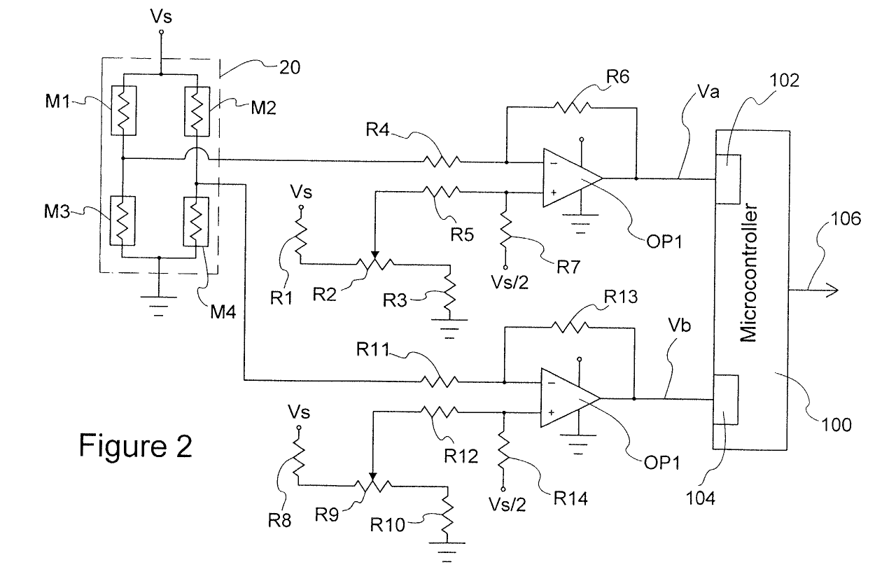

FIG. 2 illustrates suitable electronic circuitry used in conjunction with the cogwheel 12, including that of the sensor module 16 of FIG. 1. The sensor module 16 contains four magnetoresistive sensors M1, M2, M3, and M4, having instantaneous resistance values R_{M1}through R_{M4}, respectively and interconnected as illustrated in FIG. 2. To indicate the modular character of the array of sensors M1 to M4, the array is shown enclosed in broken lines and indicated by reference numeral 20 in FIG. 2, but the schematic presentation of the sensors M1 to M4 in FIG. 2 is not intended to reflect the geometry of the array, which is more accurately depicted in FIG. 1. The balance of FIG. 2 outside sensor module 20 comprises the circuit used for measuring the resistance values R_{M1} to R_{M4} and from them computing the relative angular position of the tooth 18 that is at the time immediately aligned with the sensor module 16.

Note that as the cogwheel 12 rotates with the shaft 10, the teeth 14 will continue to pass by the sensor module 16 in sequence. Unless the teeth 14 are somehow distinguishable from each other or the cogwheel 12 is otherwise marked, it is not possible to determine the absolute angular position of the shaft 10. Each of the teeth 14 looks identical to the other teeth 14 as it goes by the sensor module 16. So passage of the teeth 14 past the sensor module 16 can be used to generate variable and cumulative magnetic information that is useful for measuring the rotary speed of the shaft 10, or for measuring the relative angle of the shaft 10 as compared to a start-up position of the shaft 10, but that cannot be used in the FIG. 1 arrangement to determine the absolute angular position of the shaft 10.

The measurement circuit shown in FIG. 2 also includes two operational amplifiers OP1 and OP2, which may if desired be provided by a single module. Resistor pair R4 and R5, normally of the same resistance value, and resistor pair R6 and R7, normally of the same resistance value, determine the gain of the operational amplifier OP1, subject to fine adjustment by potentiometer R2, which is typically adjusted to limit the output voltage of operational amplifier OP1 to a range acceptable as an input voltage range to analog-to-digital converter 102, which receives the output of the operational amplifier OP1. Resistor pairs R11 and R12 of the same resistance value and R13 and R14 of the same resistance value similarly determine the gain of the operational amplifier OP2, again subject to fine adjustment by potentiometer R9, which is typically adjusted to limit the output voltage of operational amplifier OP2 to a range acceptable as an input voltage range to analog-to-digital converter 104, which receives the output of the operational amplifier OP2.

One input for operational amplifier OP1 is taken through resistor R4 from the point of connection between sensors M1 and M3. Similarly, one input for operational amplifier OP2 is taken through resistor R11 from the point of connection between sensors M2 and M4. A DC voltage Vₛ is supplied to the positive terminal of magnetoresistive sensor array 20 whose negative terminal is grounded, and also is applied to the distal terminals of resistors R1 and R8 as shown. Resistors R1 and R3, subject to the trimming offset adjustment provided by potentiometer R2, provide a voltage divider for providing an offset input voltage to operational amplifier OP1 via resistor R5. Similarly, resistors R8 and R10, again subject to the adjustment provided by potentiometer R9, provide a voltage divider for providing an offset input voltage to operational amplifier OP2 via resistor R12. The instantaneous output voltages of operational amplifiers OP1 and OP2 are respectively applied as discrete input voltages Vₐ and V_{b} to a microcontroller 100 which includes built-in analog/digital conversion circuits 102 and 104 and provides an angular position output signal 106.

It can be seen from FIG. 2 that the sensors M1 to M4 are connected so that M1 and M3 form a voltage divider providing an instantaneous voltage [R_{M3}/(R_{N1}+R_{M3})]Vₛ to the measurement circuit. Similarly, sensors M2 and M4 form a voltage divider providing an instantaneous voltage [R_{M4}(R_{N2}+R_{M4})]Vₛ to the measurement circuit. The instantaneous output voltages Vₐ and V_{b} of operational amplifiers OP1 and OP2 are provided to the analog-to-digital converter circuits 102 and 104 of the microprocessor 100. When the circuit of FIG. 2 is coupled to the sensing arrangement of FIG. 1, the microprocessor 100 calculates the relative angle of the shaft, and a signal representing the relative angle is provided as a serial output 106 of the microprocessor 100.

As mentioned above, in the circuit shown in FIG. 2, if the spacing of the sensors M1 to M4 of the linear array of sensors is small enough relative to the spacing of the threads of a screw-threaded shaft, and if the sensor array is aligned in parallel to the axis of the shaft, then the portion of the screw-threaded shaft close to the sensor module resembles the teeth of a cogwheel as the shaft turns in that there is an axial progression of the land of the thread as the shaft turns. The only difference is that because the thread of a screw-threaded shaft is helical, the spacing of the thread in the axial dimension is not exactly the same as the perpendicular distance between threads (“thread pitch”). Hence the thread pitch of the screw-threaded shaft and the spacing of the sensors in the sensor array must be properly selected so that the longitudinal extension of the array of sensors is less than the thread pitch divided by the cosine of the helical angle of the screw thread. Essentially this constraint implies that the array “fits” between any two consecutive threads of the shaft.

By using a screw-threaded shaft (having an appropriate thread pitch) instead of the cogwheel used in the prior art, and aligning the sensor module with the axis of the shaft, the angle of a single-threaded shaft can be measured absolutely because, for a single-threaded shaft, the thread passes the sensor module only once for each complete turn of the shaft. If the shaft is multi-threaded, the angular position is determined only to a portion of a full rotation, but for many applications that is sufficient.

A benefit of using a screw thread instead of the prior art cogwheel is that the screw diameter can be relatively small as compared to the cogwheel. If a cogwheel is made too small, the distance from the sensors to the teeth varies, introducing inaccuracy. Further, and importantly for some applications, the screw thread can be made with much less mass than a cogwheel, so as to have little inertia relative to that of a cogwheel.

To use the sensor module 16 of FIG. 1 and the circuit illustrated in FIG. 2 in an embodiment of the invention, the spacing of the centers of the four magnetoresistive sensors M1 to M4 of the sensor module 16 should preferably be ¼ of the thread pitch divided by the cosine of the helical angle of the screw thread. If the spacing diverges by a small amount from ¼ of the thread pitch divided by the cosine of the helical angle, then the computation algorithm in the microcontroller 100 can be designed to compensate for the variance. Note that if two sensors were used instead of four, the target spacing would be ½ of the thread pitch divided by the cosine of the helical angle, or if eight sensors were used instead of four, the target spacing would be ⅛ of the thread pitch divided by the cosine of the helical angle.

While two or eight sensors could be used instead of four, the use of four sensors provides good accuracy at relatively low cost, and requires relatively little axial space, and therefore is a good compromise between the less costly two sensors and the somewhat more accurate eight sensors. While other numbers of sensors, say five or six or seven or nine or ten sensors, could theoretically be used instead of four, the computation of the absolute shaft angle would become more complicated.

Furthermore, the thread of the screw-threaded shaft should preferably be sinusoidal in profile, although a trapezoidal profile that approximates a sinusoidal profile will work. A square-cut profile could also be made to work, but would require modifications to the analysis of the signals produced by the sensor array. A sinusoidal profile is preferred because it generates a corresponding sinusoidal variance in the magnetic field adjacent, thereby affording a linear relationship between the resistance of the magnetoresistive sensors M1, M2, M3, and M4 and the respective distance of the sensors M1, M2, M3, and M4 from the instantaneously presented thread surface. Again, the algorithm employed in the microcontroller 100 can correct for minor departures from a sinusoidal thread profile.

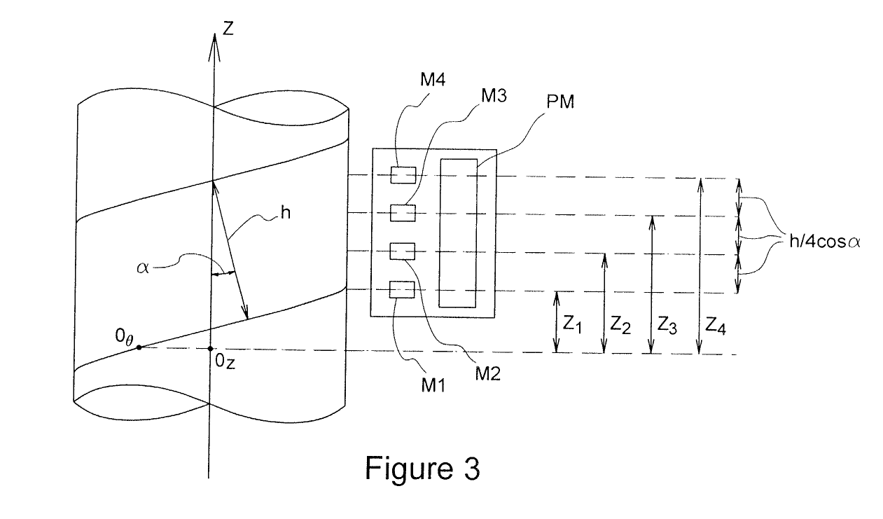

Based upon these two assumptions (appropriate sensor spacing relative to thread pitch and helical thread angle, and sinusoidal thread profile), it can be shown that the instantaneous distances of the sensors from the surface of the screw-threaded shaft can each be expressed as a linear function of the sine or cosine of a single quantity that is a linear function of the rotational angle of the shaft. The foregoing is apparent from an inspection of FIG. 3, which, while schematic in character, reveals the expected linear character of the relationship. In FIG. 3, the origin O_{θ} of the angular position coordinate for the values θ of angular position is taken as the point on the thread intercepted by a line extending from the origin O_{z} of the z-axis and perpendicular to the z-axis, the z-axis being the axis of rotation of the screw. Although in the schematic illustration of FIG. 3, the ostensible distance from each sensor M1, M2, M3, and M4 to the screw surface is the same, in actuality, because of the sinusoidal profile of the thread, the actual distance will vary in accordance with the instantaneous position of the screw at any given time of measurement, and of course will be different for each distance from the screw surface to the respective sensors M1, M2, M3, and M4 because of the sinusoidal character of the screw thread profile. That result, coupled with the experimental result that the magnetic field at any of the sensors is approximately proportional to the distance of that sensor from the surface of the screw-threaded shaft and the knowledge that the resistance of a conventional magnetoresistive sensor is proportional to the magnetic field strength, establishes that the instantaneous resistances of the magnetoresistive sensors will each be a linear function of the sine or cosine of a single quantity that in turn is a linear function of the rotational angle of the shaft.

A suitable calculation on the converted outputs of operational amplifiers OP1, OP2 by the microprocessor 100 can thus be used to measure the resistances of the magnetoresistive sensors M1, M2, M3 and M4 and from those values calculate the rotational angle of the shaft. Unlike the cogwheel 14 of the prior art, the calculated rotational angle for a screw thread is an absolute angle; it is not an incremental or relative angle obtained by sensing some feature arranged on the circumference of the shaft 10. This absolute rotational angle of the shaft can then be reported or converted to an absolute linear position based on the known relationship between the shaft rotation angle and the corresponding change in linear position.

If the threads of the shaft are multiple-threaded, then the rotational angle is absolutely determined only as between two or more possible alternative values, as the apparatus cannot determine which of the multiple threads it is sensing (more than one thread will pass any selected sensor for each full rotation of the shaft). For example, if the shaft is doubly-threaded, then the rotational angle is either the indicated angle or that angle plus or minus 180°.

Provided that the thread or threads of the shaft have a suitably matching pitch, previously known sensor arrays and data processing circuits may be used without modification, for any given sensor module of the sort previously used for cogwheel measurements. Such prior sensor modules typically are manufactured with four sensors, as schematically illustrated in FIG. 3.

To state the relationship between the voltages Vₐ and V_{b} provided to the microcontroller and the absolute angle θ of rotation of the screw-threaded shaft having threads having sinusoidal profiles, the following definitions are useful:

θ: rotational angle of the shaft (in radians), as measured from an arbitrary radial position (θ=0) of the shaft, that logically is determined as stated above, viz at the point of intersection of the thread with a line perpendicular to the z-axis and passing through the origin O_{z} of the z-axis;

ρ: radius of the threaded portion of the shaft (measured to the notional cylinder coaxial with the shaft whose cylindrical surface bisects the threads);

h: thread pitch (perpendicular distance between threads);

n: number of threads;

α: helical angle of the thread or threads (angle between a thread and a plane perpendicular to the axis of the shaft);

z: distance along the axis of the shaft.

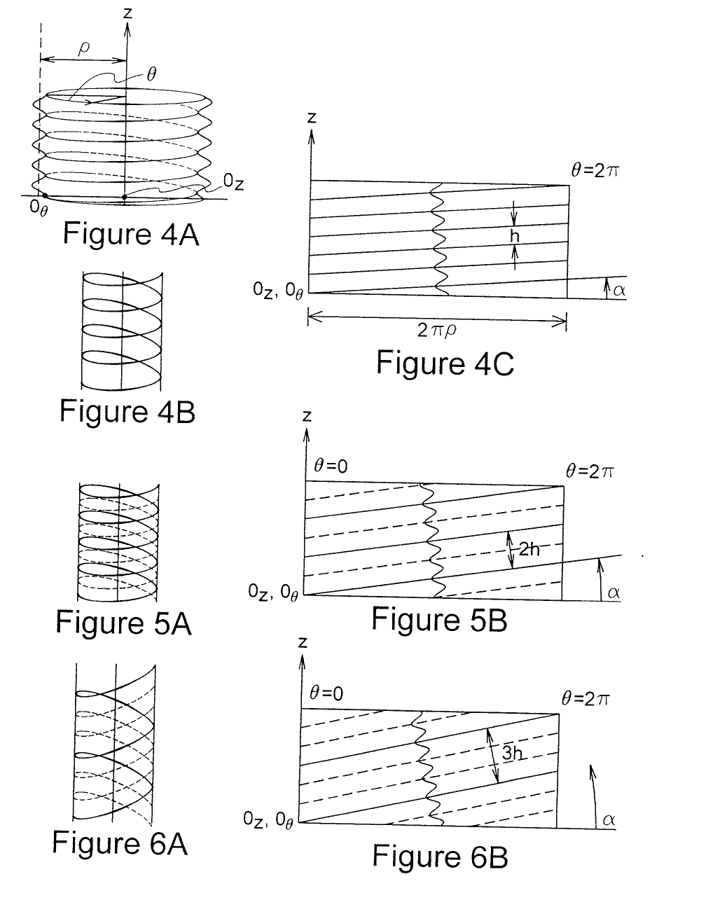

These definitions are illustrated for a fragment of a single-threaded shaft in FIGS. 4A, 4B, and 4C. FIG. 4A shows an elevation view and FIG. 4C a flat-plane extension of the same single-threaded shaft. FIG. 4B shows the helical path of the thread of FIG. 4A. In the flat-plane extension of FIG. 4C, the thread or “thread line” is projected radially onto a notional cylinder whose surface bisects the thread and then that cylinder is sliced along its intersection with the θ=0 plane and flattened out. Note that the thread line on the shaft is defined as the closest portion of the surface of the shaft to the axis of the shaft; it is the nadir of the “trough” or “valley” of the thread.

In the resulting two-dimensional representation of FIG. 4C (in which z is the ordinate and is plotted as a function of rotational angle θ) the continuous thread line is shown as a set of parallel line segments at an angle α to the abscissa. The thread line segments are spaced a distance h apart. Note that although for a single-threaded shaft there is only one single thread line, at times in the discussion below reference is made to “threads” as signifying the reappearances (in an axial sense) of the thread line as it passes helically around the shaft. Each such “thread” appears as a separate line segment in the flat-plane extension, but there is still only one thread in a single-thread screw. On the other hand, if there are more than one thread cut in the screw, and therefore more than one thread line, successive reappearances will be of a thread differing from the thread that was previously seen at a particular radial view. The meaning of “thread” will be apparent from the context.

As can be seen from FIGS. 4A and 4C, the helical angle θ is related to the pitch h by the relationship sin α=h/(2πρ) for a single-threaded screw. Note that in the drawings and in the analysis presented, a sinusoidal thread profile is assumed. To the extent that the thread profile varies from sinusoidal, relationships expressed herein and computations made by the microcontroller 100 will also vary, and depending upon the actual thread profile configuration, the variation may be non-linear and consequently the computations made may be unacceptably unreliable. Compensation for minor deviations from perfection of a sinusoidal thread profile can be effected by the provision of a suitable algorithm to be used by the microcontroller 100; such compensation and algorithm selection are best treated empirically for any given screw. Optimally, the designer should attempt to provide a thread profile as close as reasonably possible to sinusoidal.

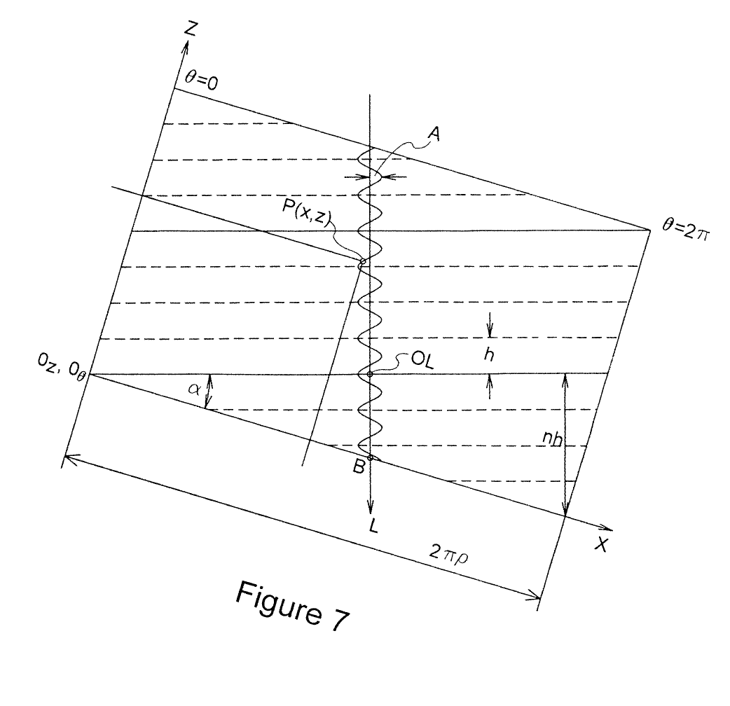

FIG. 5A shows the two threads of a double-threaded screw, one thread by a solid line and the other by a broken line. FIG. 5B is a flat-plane extension of a portion of a double-threaded screw-threaded shaft. FIGS. 6A and 6B are respective similar representations of a triple-threaded screw.

FIG. 7 is a flat-plane extension view of a quadruple-threaded shaft in a flat-plane extension and is used for the following derivation. Note that if there are n threads, then it is clear from FIG. 7 that the relationship between the helical angle θ and the pitch h is

sin α=nh/(2πρ).

The number n of screw threads is 4 for the example illustrated in FIG. 7, but the relationship given above is valid for any integral number n of screw threads.

Rather than using the rectangular coordinate axes z and x (where x=θρ) in the flat-plane extension, as illustrated in FIG. 7, it is convenient to define a coordinate axis L, also illustrated in FIG. 7, that is perpendicular to the thread line or lines, has its origin at a selected point O_{L} on the first occurrence of the thread relative to the origins of the z-axis and x-axis (or on a selected such first thread if there is more than one thread), and is oriented generally in the negative z direction, i.e. so that as the value of the z-coordinate of a given point increases, the value of the L-coordinate of that point decreases. Then the distance H from the z-axis to any point P on the surface of the screw-threaded shaft (see FIG. 7) may be written as:

H=ρ−A cos (2πN/h)

where N is the coordinate of point P along the L axis and A is the thread profile amplitude (i.e., half the radial distance between the apex and nadir of the thread profile); see, for example, FIG. 7. (Note that typically A is much less than ρ in absolute terms.) To express the distance H as a function of θ and z, the following equations are helpful:

x=θρ

OB=(x+z tan α) sin α

OP=(z/ cos α)−OB=−N

(The value OB is the distance along the L-axis between the origin O_{L} of the L-axis and the point B at which the L-axis crosses the x-axis, and the value OP is the distance along the L-axis between the origin O_{L} of the L-axis and the point P.)

Using the foregoing equations, the distance H may be expressed as follows:

H(x,z)=ρ−A cos (2π/h)[(x+z tan α) sin α−(z/ cos α)]

which can be rewritten using the relationship sin α=nh/2πρ as:

H(θ,z)=ρ−A cos (2π/h)[θρnh/2πρ−z cos α]

or, simplifying:

H(θ,z)=ρ−A cos [nθ−(2π/h)z cos α].

Hence, if z is a constant and θ varies from 0 to 2π, then H(θ,z) will be an n-cycle sinusoidal function for any number n of screw threads.

If one selects four positions on the surface of the screw-threaded shaft whose z-coordinates differ by h/(4 cos α) and whose θ-coordinates are the same, then the distances of the four points from the z-axis can be calculated. Note that h/cos α is the spacing of threads in the z-direction. Consider for the moment a single-threaded shaft. If four sensors are spaced at a spacing h/(4 cos α) in the z-direction, when the first sensor is above one thread (above the nadir of the “valley”), then the other three sensors will be spaced across the “peak” so that the fourth sensor will be at a distance equal to that same spacing from the next thread (i.e., the same thread in its next appearance). In effect the sensors will be sampling a sinusoidal function at four points that are spaced sufficiently to provide an unambiguous indication of the rotational angle of the shaft. With a perfect sinusoidal thread profile, a pure sinusoidal (and cosinusoidal) output of the magnetoresistive sensors is obtainable; as mentioned above, minor deviations from perfection are easily compensated for by means of the algorithm used by the microcontroller 100, and are best treated empirically for any given screw.

If the coordinate of the first position (i.e., the point on the screw thread radially opposite the first sensor, which is the lowermost sensor M1 in FIG. 3) is z₁, then the four positions will have the following z-coordinates (see FIG. 3):

z₁

z₂=z₁+h/(4 cos α)

z₃=z₁+h/(2 cos α)

z₄=z₁+3h/(4 cos α)

and the distances of the four points from the z axis will be:

H(θ, z₁)=ρ−A cos[nθ−(2π/h)z₁ cos α]

H(θ, z₂)=ρ−A sin[nθ−(2π/h)z₁ cos α]

H9θ, z₃)=ρ+A cos[nθ−(2π/h)z₁ cos α]

H(θ, z₄)=ρ+A sin[nθ−(2π/h)z₁ cos α]

Note that for a given screw thread, the values h, α, A and ρ are fixed and z₁ is an arbitrary constant, so it follows that the set of distances H for any value of nθ are sinusoidal functions only of nθ. Since the resistances of the magnetic sensors are approximately linearly proportional to the magnetic field at each sensor, and the magnetic field is approximately linearly proportional to the distance to the surface of the screw-threaded shaft, the angle θ can be found in the manner set out below.

If the air gap between the sensors and the screw thread is δ, then the gaps G between each of the four sensors and the adjacent surface of the shaft are:

$$\begin{matrix}{G}_{1} = δ + ρ + A - H ( θ , {z}_{1} ) \\ = δ + A + A cos [ n θ - ( 2 π / h ) {z}_{1} cos α ]\end{matrix}$$

$$\begin{matrix}{G}_{2} = δ + ρ + A - H ( θ , {z}_{2} ) \\ = δ + A + A sin [ n θ - ( 2 π / h ) {z}_{1} cos α ]\end{matrix}$$

$$\begin{matrix}{G}_{3} = δ + ρ + A - H ( θ , {z}_{3} ) \\ = δ + A - A cos [ n θ - ( 2 π / h ) {z}_{1} cos α ]\end{matrix}$$

$$\begin{matrix}{G}_{4} = δ + ρ + A - H ( θ , {z}_{4} ) \\ = δ + A - A sin [ n θ - ( 2 π / h ) {z}_{1} cos α ]\end{matrix}$$

The magnetic flux densities at the four sensors M1 to M4 are then given by:

B₁=Bₛ+BₚG₁

B₂=Bₛ+BₚG₂

B₃=Bₛ+BₚG₃

B₄=Bₛ+BₚG₄

where Bₛ and Bₚ are constants.

In the circuit shown in FIG. 2, the instantaneous resistances of the four sensors are given by:

R_{M1}=Rₛ+RₚB₁

R_{M2}=Rₛ+RₚB₂

R_{M3}=Rₛ+RₚB₃

R_{M4}=Rₛ+RₚB₄

where Rₛ and Rₚ are constants.

From the foregoing and substituting the other relationship given above, one obtains:

R_{M1}=R₀+R_{A} cos [nθ−(2π/h)z₁ cos α]

R_{M2}=R₀+R_{A} sin [nθ−(2π/h)z₁ cos α]

R_{M3}=R₀+R_{A} cos [nθ−(2π/h)z₁ cos α]

R_{M4}=R₀+R_{A} cos [nθ−(2π/h)z₁ cos α]

where R₀=Rₛ+RₚBₛ+RₚBₚ(δ+A), and

R_{A}=RₚBₚA.

If the supply voltage is Vₛ, then the voltage V_{Ma} is given by:

$$\begin{matrix}{V}_{ma} = {V}_{s} {R}_{M3} / ( {R}_{M1} + {R}_{M3} ) \\ = {V}_{s} \{ {R}_{0} - {R}_{A} cos [ n θ - ( 2 π / h ) {z}_{1} cos α ] \} / 2 {R}_{0}\end{matrix}$$

or V_{Ma}=Vₛ/2−(R_{A}/2R₀)Vₛcos[nθ−(2πh)z₁ cos α] and similarly V_{Mb}=Vₛ/2−(R_{A}/2R₀)Vₛ sin [nθ−(2π/h)z₁ cos α]

If the gains of the operational amplifiers OP1 and OP2 are each γ, then the output voltages Vₐ and V_{b} of the operational amplifiers OP1 and OP2 transmitted therefrom to the microcontroller 100 and digitized by the microcontroller 100 are:

Vₐ=Vₛ/2+Vₘ cos [nθ−(2π/h)z₁ cos α], and

V_{b}=Vₛ/2+Vₘ sin [nθ−(2π/h)z₁ cos α]

where Vₘ=γ(R_{A}/2R₀)Vₛ.

The absolute angle of the shaft position can then be calculated from the digitized voltages Vₐ and V_{b} using previously known standard mathematical techniques as follows:

Let C=Vₘ cos φ and S=Vₘ sin φ,

where φ is given by φ=nθ−(2π/h)z₁ cos α.

Then the absolute value of tanφ is calculated as the absolute value of the ratio S/C. From a lookup table and the ± signs of C and S, φ can be determined. For example, if both C and S are positive, φ must be in the first quadrant (of a conventional Cartesian orthogonal graph), so φ is the arctan of S/C. If C is negative and S is positive, then φ must be in the second quadrant and therefore equals (π−arctan of the absolute value of S/C). Similarly for both C and S negative, φ must be in the third quadrant and φ is (π+arctan of the absolute value of S/C). Finally, if C is positive and S is negative, then φ must be in the fourth quadrant and φ is (2π−arctan of the absolute value of S/C). The foregoing determinations can easily be made by the microcontroller 100.

Once φ is determined, then φ is determined for a fixed value z₁ as:

θ=[φ+(2π/h)z₁ cos α]/n

Depending upon the number of threads, θ is determined absolutely within a range. For n=1, θ is determined absolutely in the full rotational range of 0 to 360°. If n=2 (a double-threaded screw shaft), then θ is determined absolutely within a range of 0 to 180°. More generally, for n threads, θ is determined absolutely within a range of 0 to 360/n°.

All of the foregoing calculations can be made by the microcontroller 100 in response to the appropriate input parameters and intermediately calculated parameters. Preferably the microcontroller computes the value of φ in the manner discussed above, and then computes the value of θ. Where possible and convenient, computations should be made and parameters selected where relationships are linear or relatively linear. The design may facilitate this objective by selecting a sinusoidal thread profile.

Note that the magnetic field sensor module 16 must be aligned so as to measure the magnetic field strength in at least two positions located along a line parallel to the z-axis of the screw-threaded shaft with the individual sensors spaced a distance apart of less than the thread pitch divided by, in the case of two sensors, twice the cosine of the helical angle. As mentioned above, four sensors are typically provided in conventional modules, so typically the sensors are spaced apart by h/(4 cos α) in the z direction, as discussed previously.

If θ is fixed (rather than z₁), then the apparatus can be used to determine the absolute linear position of the shaft relative to the sensor module. Then

z₁=h(nθ−φ)/(2π cos α)

However, both angular and linear position cannot be measured at the same time with a single sensor array.

Variants of the inventive apparatus will readily occur to those skilled in the art. For example, Hall-effect sensors could be substituted for magnetoresistive devices, albeit with different connections and other appropriate adjustments to circuitry and to the calculations. Laser or ultrasonic techniques could also be substituted for the magnetoresistive technique described above. The invention is not limited to the specific preferred embodiment illustrated and described above, but is to be accorded the full scope set forth in the appended claims.

### EXAMPLE

For a screw thread of radius approximately 4 mm and pitch 2.25 mm, the sensor module 16 used may, for example, be a Sony DM-211A/DM-211A-L module. The module contains a permanent magnet developing a magnetic field measured (in electromagnetic terms) as about 8000 amperes per metre, and also contains the four magnetoresistive sensors M1 through M4, whose centers are spaced approximately 0.565 mm apart in a linear array. In this example, the value A=0.5 mm.

For a Sony DM-211A/DM-211A-L magnetoresistive sensor module, voltage Vₛ may be supplied at 5 volts throughout FIG. 2 as illustrated. The operational amplifiers OP1 and OP2, of FIG. 2 may be provided in a single Analog Devices operational amplifier module OP281. The microcontroller 100 may be an NEC model μPD70F3003 microcontroller.

Suitable approximate values for the resistors R1 to R14 in the circuit shown in FIG. 2 are as follows:

R1, R3, R8, R10: each 100 ohms

R2, R9: each 47 ohms

R4, R5, R11, R12: each 10 kilohms

R6, R7, R13, R14: each 150 kilohms

Potentiometers R2 and R9 were set to provide an average output voltage of operational amplifiers OP1 and OP2 of about 2.5 volts, which is about the middle of the range suitable as an input voltage to the analog-to-digital converters 102 and 104.

I claim:

1. An apparatus for determining the absolute angular position or absolute linear position of a rotating shaft, comprising:
(a) one or more screw threads carried on and axially aligned with said rotating shaft;
(b) a sensor array comprised of a plurality of magnetic field strength sensors in uniform longitudinal spaced alignment parallel to the axis of rotation of said rotating shaft, wherein each sensor in said plurality of sensors is operative to sense the instantaneous intensity of a magnetic field in a region proximate a portion of said rotating shaft and generates an electrical output signal representative of said field intensity; and
(c) a signal processing apparatus coupled to said sensor array operative to sense electrical output signals corresponding to each of said sensors, and to process said output signals to compute a phase change corresponding to screw threads passing a given one of said sensors due either to rotation or to linear movement of said shaft.

2. The apparatus according to claim 1, wherein said phase change is combined with a pitch of said screw threads to yield a magnitude of linear movement of said rotating shaft.

3. The apparatus according to claim 1, wherein said phase change is used to calculate an absolute measure of angular rotation of said rotating shaft.

4. The apparatus according to claim 1, wherein the distance between the first and last sensors in said sensor array is equal to the thread pitch of said screw thread or screw threads and the distance between adjacent ones of said sensors is equal to h/x cos α, where x is the number of said sensors in said sensor array, and α is the helical angle of said screw thread or screw threads.

5. The apparatus according to claim 1, additionally comprising: a magnet proximate to said sensor array and positioned to establish a magnetic field directed through said sensors in said sensor array and to said screw thread or threads.

6. The apparatus according to claim 1, wherein the thread profile of the threaded portion of the shaft is sinusoidal or approximately sinusoidal (e.g., trapezoidal).

7. The apparatus according to claim 1, wherein the number of said sensors in said sensor array is 4.

8. The apparatus according to claim 1, wherein said signal processing apparatus also processes said output signals to compute a rate of phase change corresponding to screw threads passing a given one of said sensors.

9. The apparatus according to claim 8, wherein said rate of phase change is used to calculate an absolute measure of angular velocity of said rotating shaft.

10. A method for determining the absolute angular position or absolute linear position of a rotating shaft, comprising:
(a) rotating one or more axially aligned screw threads on said rotating shaft;
(b) positioning a sensor array comprised of a plurality of magnetic field strength sensors in uniform longitudinal spaced alignment parallel to the axis of rotation of said rotating shaft, wherein each sensor in said plurality of sensors is operative to sense the instantaneous intensity of a magnetic field in a region proximate a threaded portion of said rotating shaft and generates an electrical output signal representative of said field intensity;
(c) sensing electrical output signals corresponding to each of said sensors in a signal processing apparatus; and
(d) processing said electrical output signals to compute a phase change corresponding to screw threads passing a given one of said sensors due either to rotation or to linear movement of said rotating shaft.

11. The method of claim 10, additionally comprising:
combining said phase change with a pitch of said screw threads to yield a magnitude of linear movement of said shaft.

12. The method of claim 10, additionally comprising:
calculating from said phase change an absolute measure of angular rotation of said rotating shaft.
